(19) United States
(12) Patent Application Publication
(10) Pub. No.: US 2014/0314937 A1
(43) Pub. Date: Oct. 23, 2014

(54) SYSTEM AND METHOD OF LIQUID MEASURING AND MIXING AND DEVICES THEREOF

(71) Applicant: ReJigger Cocktails LLC, Oakland, CA (US)

(72) Inventor: Marcus Chia-Jui Wang, Oakland, CA (US)

(73) Assignee: ReJigger Cocktails LLC, Oakland, CA (US)

(21) Appl. No.: 14/251,560

(22) Filed: Apr. 11, 2014

Related U.S. Application Data
(60) Provisional application No. 61/812,852, filed on Apr. 17, 2013.

(51) Int. Cl. A47J 43/27; C12G 3/04

(52) U.S. Cl. CPC A47J 43/27; C12G 3/04
USPC 426/590; 220/568

(57) ABSTRACT

Described are a cocktail preparation system, a liquid measuring and mixing device, and a method of measuring and mixing liquids. A liquid measuring and mixing device involves a measuring cup comprising a circular cross-section and one or more protruding cavities thereof joined by a plurality of support members spanning a length of the circular cross-section, the one or more protruding cavities being of calculated volumes for the purpose of accurately measuring volumes of liquid. A cocktail preparation system includes the measuring cup as described in addition to a mixing cup within which the measuring cup fits to form a sealed cocktail shaker for the purpose of mixing of the measured volumes of liquid. A method of measuring and mixing liquids involves accurately measuring two or more volumes of liquid in the measuring cup, placing the measuring cup within the mixing cup, and subsequently shaking the combination to create a cocktail.

### FIELD OF TECHNOLOGY

This disclosure relates generally to mixology devices and, more particularly, to a system, a device, and a method of measuring and mixing liquids.

### BACKGROUND

Jiggers are commonly utilized to precisely and accurately measure volumes of liquids and dispense them into separate containers (e.g. a cocktail shaker) for mixing. A mixed drink may require a specific proportion of different liquids to achieve a distinct texture, taste, and/or consistency. As such, inaccurate measurements of the different liquids may cause the ratio of the different liquids to deviate from the required ratio for the mixed drink, which may negatively impact the texture, taste, and/or consistency of the mixed drink.

The process of preparing a mixed drink may require shaking of the different liquids with ice in a cocktail shaker. Furthermore, the mixed drink may need to be dispensed into a final serving glass. This process may be lengthy and may require numerous receptacles (e.g. jigger, cocktail shaker, serving glass). Additionally, the overall volume of the mixed drink may be reduced due to traces and residue left on the interior walls of the jigger and the cocktail shaker.

### SUMMARY

Disclosed are a system, a device, and a method of measuring and mixing liquids.

In one aspect, a cocktail preparation system includes a measuring cup comprising a circular cross-section and one or more protruding cavities thereof joined by a plurality of support members spanning a length of the circular cross-section. The one or more protruding cavities are of calculated volumes for the purpose of accurately measuring volumes of liquid for mixing. The cocktail preparation system also includes a mixing cup within which the measuring cup fits to form a sealed cocktail shaker for the purpose of mixing of the measured volumes of liquid.

The support members of the measuring cup may be arcuate support members. The measuring cup may comprise a tapered rim. Alternatively, the measuring cup may comprise a lipped rim, which may rest on the rim of the mixing cup, allowing the measuring cup to fit within the mixing cup for easy storage. The interior of each of the one or more protruding cavities may include one or more indicators of volume. The one or more indicators of volume may be protrusions and/or grooves. Each of the one or more protruding cavities may be of a calculated volume ranging from ½ oz. to 2 oz. The distal ends of the one or more protruding cavities may collectively form a concave shape to facilitate a secure grip of the measuring cup during mixing.

In another aspect, a liquid measuring and mixing device is a measuring cup comprising a circular cross-section and one or more protruding cavities thereof joined by a plurality of support members spanning a length of the circular cross-section. The one or more protruding cavities are of calculated volumes for the purpose of accurately measuring volumes of liquid for mixing. The measuring cup fits within a mixing cup to form a sealed cocktail shaker for the purpose of mixing the measured volumes of liquid.

The support members of the measuring cup may be arcuate support members. The measuring cup may comprise a tapered rim. Alternatively, the measuring cup may comprise a lipped rim, which may rest on the rim of the mixing cup, allowing the measuring cup to fit within the mixing cup for easy storage. The interior of each of the one or more protruding cavities may include one or more indicators of volume. The one or more indicators of volume may be protrusions and/or grooves. Each of the one or more protruding cavities may be of a calculated volume ranging from ½ oz. to 2 oz. The distal ends of the one or more protruding cavities may collectively form a concave shape to facilitate a secure grip of the measuring cup during mixing.

In yet another aspect, a method of measuring and mixing liquids involves: accurately measuring two or more volumes of liquid in a measuring cup comprising a circular cross-section and one or more protruding cavities thereof joined by a plurality of support members spanning a length of the circular cross-section, the one or more protruding cavities being of calculated volumes; dispensing the two or more volumes of liquid into a mixing cup by placing the measuring cup within the mixing cup to form a sealed cocktailed shaker; and shaking the sealed cocktail shaker to mix the two or more volumes of liquid together.

Measuring the two or more volumes of liquid in the measuring cup may further involve measuring each of the two or more volumes of liquid in a separate cavity of the one or more protruding cavities such that the two or more volumes of liquid do not combine.

The measuring cup may comprise a tapered rim. Alternatively, the measuring cup may comprise a lipped rim, which may rest on the rim of the mixing cup, allowing the measuring cup to fit within the mixing cup for easy storage. The interior of each of the one or more protruding cavities may include one or more indicators of volume. The one or more indicators of volume may be protrusions and/or grooves. Each of the one or more protruding cavities may be of a calculated volume ranging from ½ oz. to 2 oz. The distal ends of the one or more protruding cavities may collectively form a concave shape to facilitate a secure grip of the measuring cup during mixing.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a perspective view of a measuring cup, according to one or more embodiments.

FIG. 2 is a top-down view of the measuring cup of FIG. 1, according to one or more embodiments.

FIG. 3 is a perspective view of a cocktail shaker comprising the measuring cup of FIG. 1 placed within a mixing cup, according to one or more embodiments.

FIG. 4A is a vertical cross-section of a measuring cup illustrating a tapered rim, according to one or more embodiments.

FIG. 4B is a vertical cross-section of a measuring cup illustrating a lipped rim, according to one or more embodiments.

FIG. 5 is a perspective view of the measuring cup of FIG. 1 with indicators of volume within the interior of the protruding cavities, according to one or more embodiments.

FIG. 6 is a process flow chart of a method of measuring and mixing liquids using the measuring cup of FIG. 1, according to one or more embodiments.

Other features of the present embodiments will be apparent from the accompanying drawings and from the detailed description that follows.

### DETAILED DESCRIPTION

Example embodiments, as described below, may be used to provide a cocktail preparation system, a device for measuring and mixing liquids, and a method of measuring and mixing liquids.

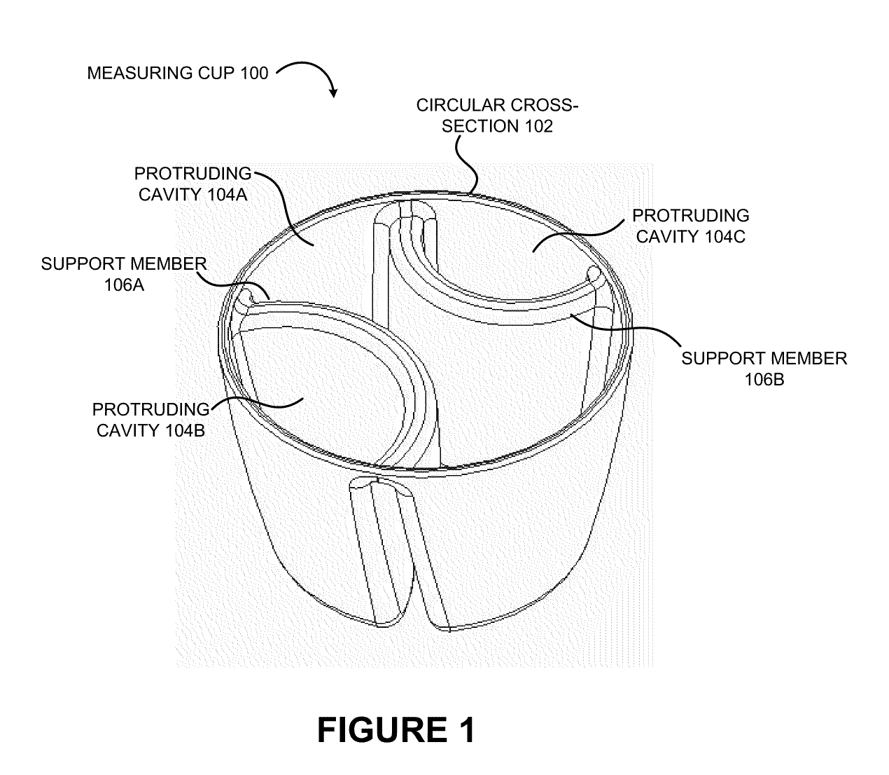

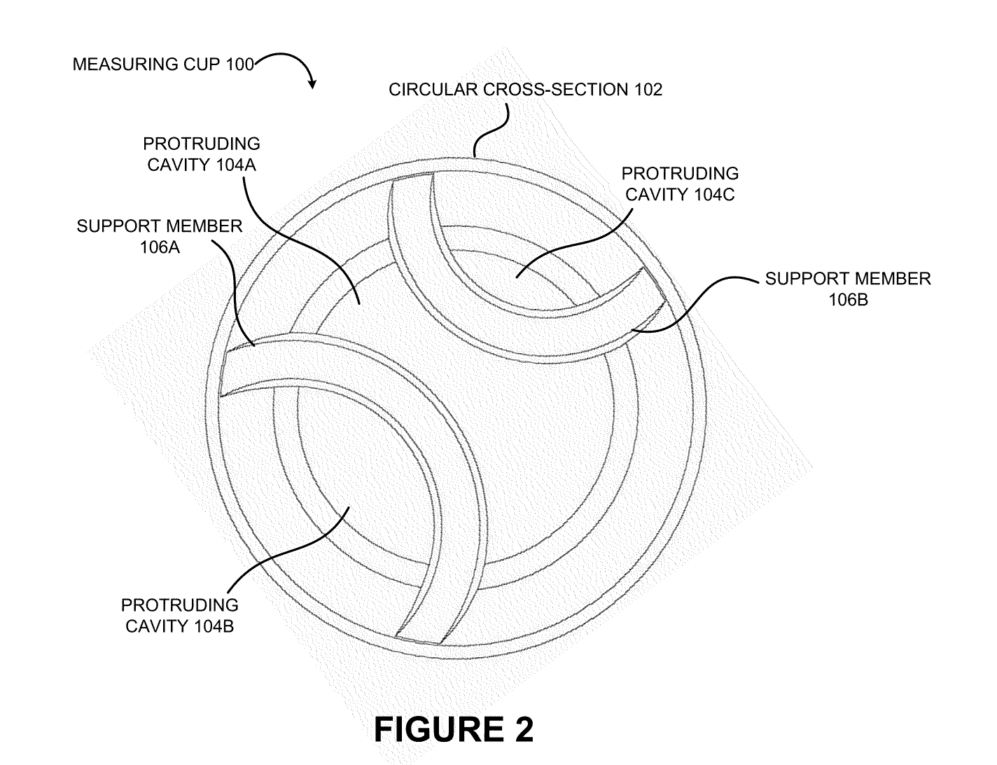

Reference is made to FIG. 1 and FIG. 2, which illustrates a perspective view and a top-down view of a measuring cup, respectively, according to one or more embodiments. In one embodiment, the measuring cup 100 may be a liquid measuring and mixing device. The measuring cup 100 comprises a circular cross-section 102 and one or more protruding cavities 104A-C that extend from the circular cross-section 102 (e.g. the one or more protruding cavities 104A-C originating at the circular cross-section 102). The one or more protruding cavities 104A-C may comprise an open end at which the each of the one or more protruding cavities 104A-C is joined along the circular cross-section 102. In addition, each of the one or more protruding cavities 104A-C may comprise a distal end (e.g. distal to the circular cross-section 102) that protrudes from the circular cross-section 102. FIGS. 1 and 2 depict a total of three protruding cavities; however, other numbers of protruding cavities are within the scope of the exemplary embodiments described herein.

The protruding cavities are joined at the circular cross-section 102 by a plurality of support members 106A-B, which span a length of the circular cross-section 102. As such, the protruding cavities 104A-C may not share lateral sidewalls. Rather, there may be a gap between the protruding cavities 104A-C. This may enable stacking of a plurality of measuring cups in which the protruding cavity(ies) of one measuring cup may fit securely inside the protruding cavity(ies) of another measuring cup and so forth.

The one or more protruding cavities 104A-C are of calculated volumes and are chosen according to a proportion generally used to make cocktails. In one embodiment, the interior(s) of the one or more protruding cavities 104A-C may comprise one or more volume indicators to allow for a greater assortment of volume proportions. In one embodiment, the volume indicators may take the form of protrusions from the surface of the interior(s) of the one or more protruding cavities 104A-C, or may take the form of grooves within the surface of the interior(s) of the one or more protruding cavities 104A-C.

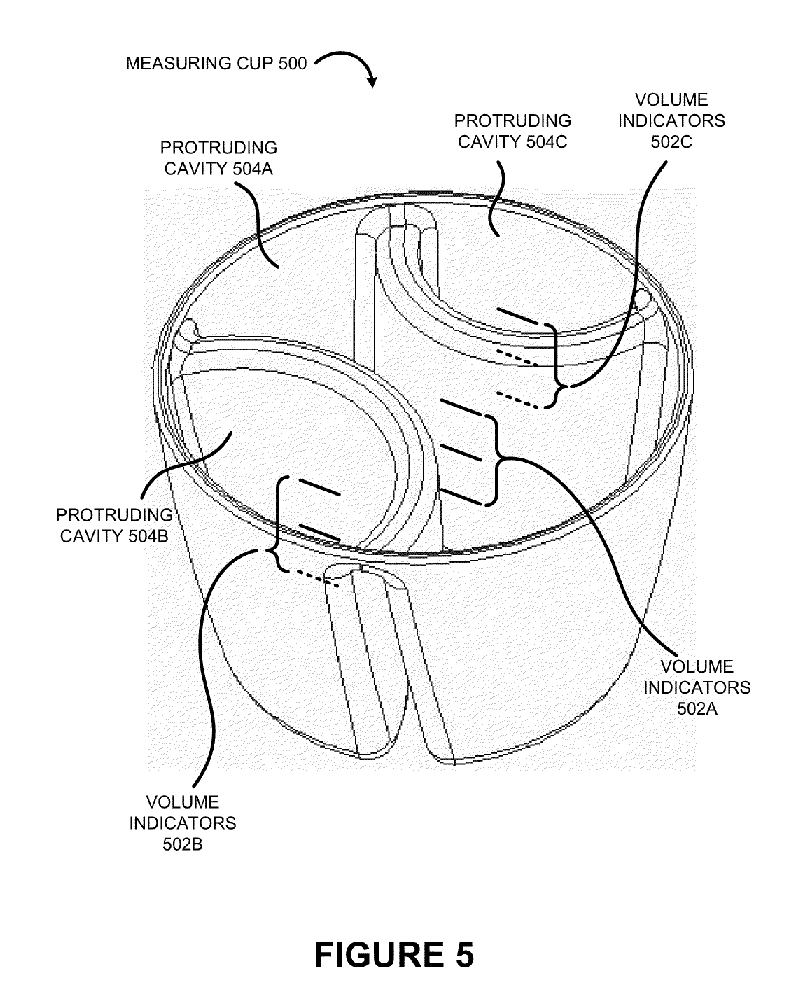

Reference is now made to FIG. 5, which is a perspective view of a measuring cup 500 further comprising one or more volume indicators within the interior(s) of the protruding cavities, according to one or more embodiments. For example, the volume of protruding cavity 504A may be 2 fl. oz. The volume indicators 502A may indicate measurements of 0.5 fl. oz., 1 fl. oz., and 1.5 fl. oz. In another example, the volume of protruding cavity 504B may be 1 fl. oz. The volume indicators 502B may specifically indicate measurements of 0.25 fl. oz., 0.5 fl. oz., and 0.75 fl. oz. In yet another example, the volume of protruding cavity 504C may be 0.5 fl. oz. The volume indicators 502C may measure 0.125 fl. oz., 0.25 fl. oz., and 0.375 fl. oz. Other volumes of the one or more protruding cavities 504A-C and the measurements indicated by the volume indicators 502A-C may be within the scope of the exemplary embodiments discussed herein.

In the preferred embodiment, and as shown in FIG. 1, the support members 106A-B of the measuring cup 100 may be arcuate support members. Differing shapes of the support members do not contribute to the overall utility of the measuring cup 100 and as such, may be within the scope of the exemplary embodiments discussed herein.

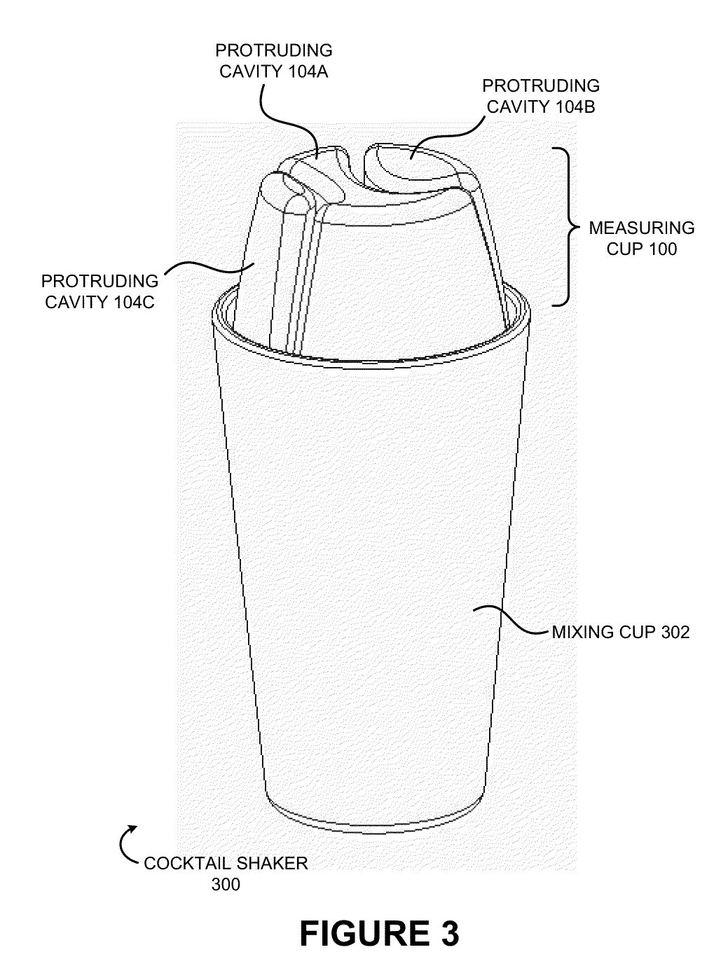

In one embodiment, the measuring cup 100 may be utilized to accurately measure two or more volumes of liquid for the purpose of preparing a cocktail. Reference is now made to FIG. 3, illustrating a cocktail preparation system comprising the measuring cup 100 and a mixing cup 302, according to one or more embodiments. The measuring cup 100 may be overturned and placed within the mixing cup 302 (e.g. with the protruding cavities 104A-C extending away from the mixing cup 302) to form a sealed cocktail shaker 300. As such, the two or more volumes of liquid are dispensed into the mixing cup 302. The cocktail shaker 300 may be subsequently shaken to mix the two or more volumes of liquid together to create a cocktail. In one embodiment, the distal ends of the plurality of protruding cavities 104A-C may collectively form a concave shape to facilitate a secure grip of the measuring cup 100 during mixing.

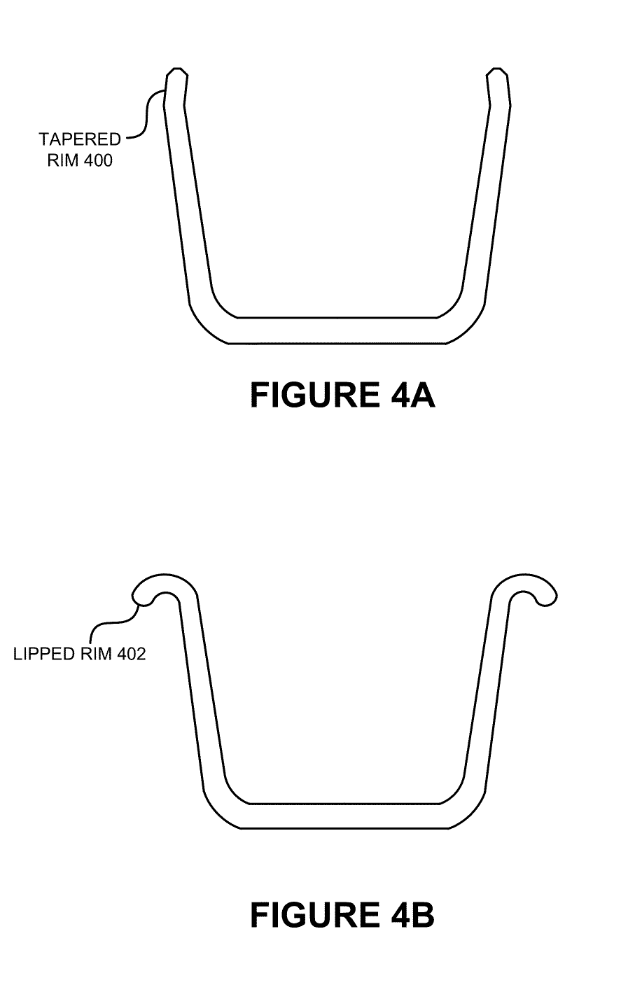

Reference is now made to FIG. 4A-B, which illustrate vertical cross-sections of the measuring cup 100 of FIG. 1, according to one or more embodiments. In one embodiment, the periphery of the circular cross-section (e.g. the rim of the cup) may be a tapered rim 400. The tapered rim 400 may be flush with the walls of the mixing cup 302 due to a matching angle of the tapered rim 400 and the walls of the mixing cup 302 with the normal. The tapered rim 400 may facilitate a tight seal when placed within the mixing cup 302 of FIG. 3 (e.g. with the one or more protruding cavities 104A-C extending away from the mixing cup 302) to form the cocktail shaker 300, preventing a breach of liquid from the cocktail shaker 300. Alternatively, to form the cocktail shaker 300, a pint glass may be used in place of the mixing cup 302.

In another embodiment, the periphery of the circular cross-section (e.g. the rim of the cup) may be a lipped rim 402. The lipped rim 402 may facilitate the storage of the measuring cup 100 within the mixing cup 302 by allowing the measuring cup 100 to hang on the rim of the mixing cup 302 (e.g. with the protruding cavities extending into the mixing cup 302) by the lipped rim 402. The measuring cup 100 may then be easily lifted from the mixing cup 302 for further operation. Alternately, an ordinary pint glass may be used in place of the mixing cup 302 and is within the scope of the exemplary embodiments discusses herein.

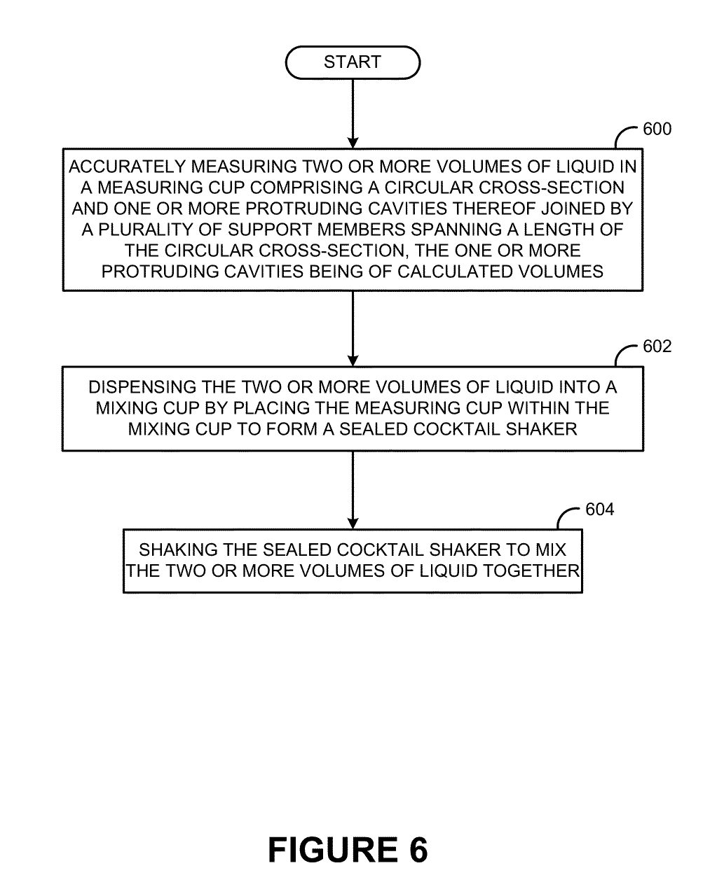

FIG. 6 illustrates a process flow chart of a method of measuring and mixing liquids using the measuring cup of FIG. 1, according to one or more embodiments. Operation 600 involves accurately measuring two or more volumes of liquid in a measuring cup comprising a circular cross-section and one or more protruding cavities thereof joined by a plurality of support members spanning a length of the circular cross-section, the one or more protruding cavities being of calculated volumes. Operation 602 involves dispensing the two or more volumes of liquid into a mixing cup by placing the measuring cup within the mixing cup to form a sealed cocktail shaker. Operation 604 involves shaking the sealed cocktail shaker to mix the two or more volumes of liquid together.

What is claimed is:

1. A cocktail preparation system comprising:
a measuring cup comprising a circular cross-section and one or more protruding cavities thereof joined by a plurality of support members spanning a length of the circular cross-section, the one or more protruding cavities being of calculated volumes for the purpose of accurately measuring volumes of liquid for mixing; and
a mixing cup within which the measuring cup fits to form a sealed cocktail shaker for the purpose of mixing of the measured volumes of liquid.

2. The cocktail preparation system of claim 1, wherein the support members are arcuate support members.

3. The cocktail preparation system of claim 1, wherein the measuring cup further comprises a tapered rim.

4. The cocktail preparation system of claim 1, further comprising:
wherein the measuring cup further comprises a lipped rim, and
wherein the lipped rim of the measuring cup rests on the rim of the mixing cup, allowing the measuring cup to fit within the mixing cup for easy storage.

5. The cocktail preparation system of claim 1, wherein an interior of each of the one or more protruding cavities comprises one or more volume indicators.

6. The cocktail preparation system of claim 5, wherein the one or more volume indicators are at least one of: one or more protrusions and one or more grooves.

7. The cocktail preparation system of claim 1, wherein each of the one or more protruding cavities is of a calculated volume ranging from ½ oz. to 2 oz.

8. The cocktail preparation system of claim 1, wherein the distal ends of the one or more protruding cavities collectively form a concave shape to facilitate a secure grip of the measuring cup during mixing.

9. A liquid measuring and mixing device comprising:
a measuring cup comprising a circular cross-section and one or more protruding cavities thereof joined by a plurality of support members spanning a length of the circular cross-section, the one or more protruding cavities being of calculated volumes for the purpose of accurately measuring volumes of liquid for mixing,
wherein the measuring cup fits within a mixing cup to form a sealed cocktail shaker for the purpose of mixing the measured volumes of liquid.

10. The liquid measuring and mixing device of claim 9, wherein the support members are arcuate support members.

11. The liquid measuring and mixing device of claim 9, wherein the measuring cup further comprises a tapered rim.

12. The liquid measuring and mixing device of claim 9, further comprising:
wherein the measuring cup further comprises a lipped rim, and
wherein the lipped rim of the measuring cup rests on the rim of the mixing cup, allowing the measuring cup to fit within the mixing cup for easy storage.

13. The liquid measuring and mixing device of claim 9, wherein an interior of each of the one or more protruding cavities comprises one or more volume indicators.

14. The liquid measuring and mixing device of claim 13, wherein the one or more volume indicators are at least one of: one or more protrusions and one or more grooves.

15. The liquid measuring and mixing device of claim 9, wherein each of the one or more protruding cavities is of a calculated volume ranging from ½ oz. to 2 oz.

16. The liquid measuring and mixing device of claim 9, wherein the distal ends of the one or more protruding cavities collectively form a concave shape to facilitate a secure grip of the measuring cup during mixing.

17. A method of measuring and mixing liquids comprising:
accurately measuring two or more volumes of liquid in a measuring cup comprising a circular cross-section and one or more protruding cavities thereof joined by a plurality of support members spanning a length of the circular cross-section, the one or more protruding cavities being of calculated volumes;
dispensing the two or more volumes of liquid into a mixing cup by placing the measuring cup within the mixing cup to form a sealed cocktail shaker; and
shaking the sealed cocktail shaker to mix the two or more volumes of liquid together.

18. The method of claim 17, wherein accurately measuring the two or more volumes of liquid in the measuring cup further comprises measuring each of the two or more volumes of liquid in a separate cavity of the one or more protruding cavities such that the two or more volumes of liquid do not combine.

19. The method of claim 17, wherein the measuring cup further comprises a tapered rim.

20. The method of claim 17, further comprising:
wherein the measuring cup further comprises a lipped rim, and
wherein the lipped rim of the measuring cup rests on the rim of the mixing cup, allowing the measuring cup to fit within the mixing cup for easy storage.

21. The method of claim 17, wherein an interior of each of the one or more protruding cavities comprises one or more volume indicators.

22. The method of claim 21, wherein the one or more volume indicators are at least one of: one or more protrusions and one or more grooves.

23. The method of claim 17, wherein each of the one or more protruding cavities is of a calculated volume ranging from ½ oz. to 2 oz.

24. The method of claim 17, wherein the distal ends of the one or more protruding cavities collectively form a concave shape to facilitate a secure grip of the measuring cup during mixing.
